(19) United States
(12) Patent Application Publication
(10) Pub. No.: US 2015/0167868 A1
(43) Pub. Date: Jun. 18, 2015

(54) Maple sap vacuum collection systems with chew proof tubing

(71) Applicant: Scott Boncha, Chardon, OH (US)

(72) Inventor: Scott Boncha, Chardon, OH (US)

(21) Appl. No.: 14/109,940

(22) Filed: Dec. 17, 2013

(51) Int. Cl. F16L 11/10; F16L 11/12

(52) U.S. Cl. CPC F16L 11/10; F16L 11/124

(57) ABSTRACT

Spiral wrapped tubing for use in a maple sap vacuum system. Flexible tubing is covered with a spiral wrap in such a manner that the flexible tubing still maintains its flexibility for tight bends. The single spiral wrapped tube typically has a clear outer coating. The spiral wrap can be applied in several ways. The first criteria is the number of spirals being applied to a tube, in one embodiment, a single spiral is shown, but it should be appreciated that multiple spirals of any number can be used as desired. Additionally, the width of the spirals can be adjusted as well. After wrapping, the exterior can be coated or left un-coated. The spacing between each spiral can also be increased or decreased in size, which effects weight, protection, and flexibility.

### FEDERALLY SPONSORED RESEARCH

Not Applicable

### SEQUENCE LISTING OR PROGRAM

Not Applicable

### CROSS REFERENCE TO RELATED APPLICATIONS

Not Applicable

### TECHNICAL FIELD OF THE INVENTION

The present invention relates generally to Maple sap vacuum collection systems. More specifically, the present invention relates to Maple sap vacuum collection systems and an improved tube design.

### BACKGROUND OF THE INVENTION

Maple sap vacuum collection systems are set up much like a tree. Large trunk lines branch off to smaller lines eventually branching off to a 5/16 ID tubes that are attached to the trees for collecting the sap. The 5/16 lines are where most of the damage occurs as they are longer and their size makes them more attractive to animals. Currently there are many types of tubing on the market that would be chew proof however they are too costly for use. This tubing is reinforced with metal or other materials to increase it pressure handling capacity or to make it crush resistant etc. and is not directed to solving the problem of animal damage.

### SUMMARY OF THE INVENTION

The present invention is spiral wrapped tubing for use in a maple sap vacuum system. Flexible tubing is covered with a spiral wrap in such a manner that the flexible tubing still maintains its flexibility for tight bends. The single spiral wrapped tube typically has a clear outer coating, for illustrative purposes, but would typically be covered with a colored coating. The spiral wrap can be applied in several ways. The first criteria is the number of spirals being applied to a tube, in one embodiment, a single spiral is shown, but it should be appreciated that multiple spirals of any number can be used as desired. Additionally, the width of the spirals can be adjusted as well. After wrapping, the exterior can be coated or left un-coated depending of if additional animal resistance is necessary for the application or location in which the tubes will be deployed into the field. Color can also be adjusted. Typically used colors are white, light green, or light blue but any color can be chosen and manufactured as required. The spacing between each spiral can also be increased or decreased in size, which effects weight, protection, and flexibility. Depending on the environment and other conditions, the wrapping can be adjusted to the specific environmental setting and threats.

The sole purpose of the reinforcement as applied to the tubing and taught by the present invention is to make the tubing resistant to animals chewing through and thus losing the vacuum in the system. The present invention is not concerned with increasing the pressure handling capacity or crush resistance properties of the tubing.

### BRIEF DESCRIPTION OF THE DRAWINGS

The accompanying drawings, which are incorporated herein a form a part of the specification, illustrate the present invention and, together with the description, further serve to explain the principles of the invention and to enable a person skilled in the pertinent art to make and use the invention.

FIG. 1 illustrates that the spiral wrap of the present invention still maintains flexibility for tight bends;

FIGS. 2-3 illustrate the triple spiral wrapped tube;

FIGS. 4-5 illustrate the wide spiral wrapped tube;

FIG. 6 illustrates a single spiral wrap embodiment of the present invention, which is bonded to the tube which would eliminate the outer coating; and

FIG. 7 illustrates a single spiral wrap embodiment of the present invention without the tubing.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

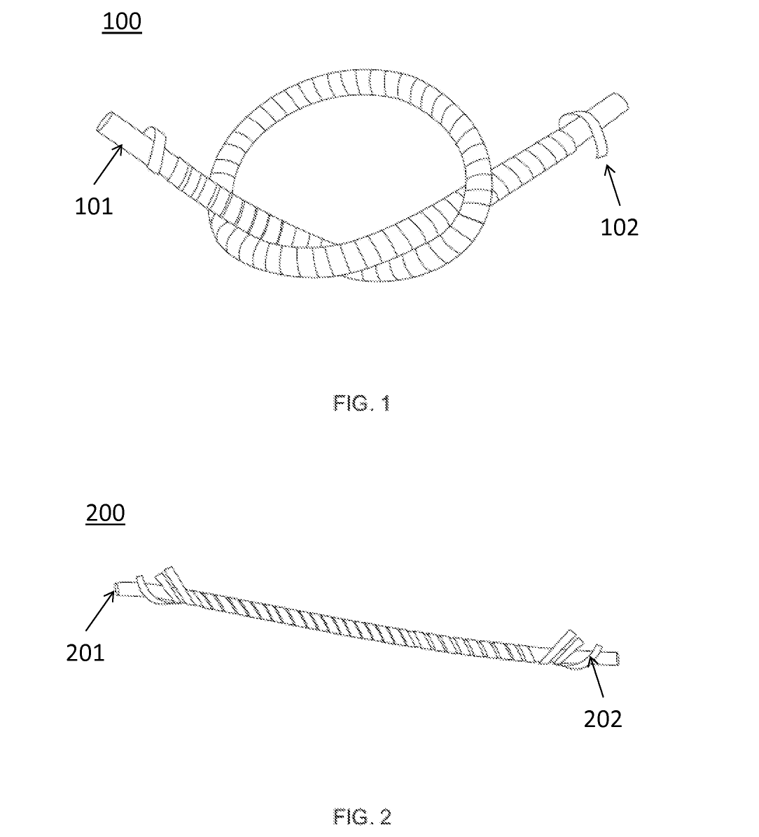

Now referring to the Figures, the embodiment of the spiral wrapped tubing 100 for use in a maple sap vacuum system is disclosed. As show in FIG. 1, flexible tubing 101 is covered with a spiral wrap 102 in such a manner that the flexible tubing 101 still maintains its flexibility for tight bends.

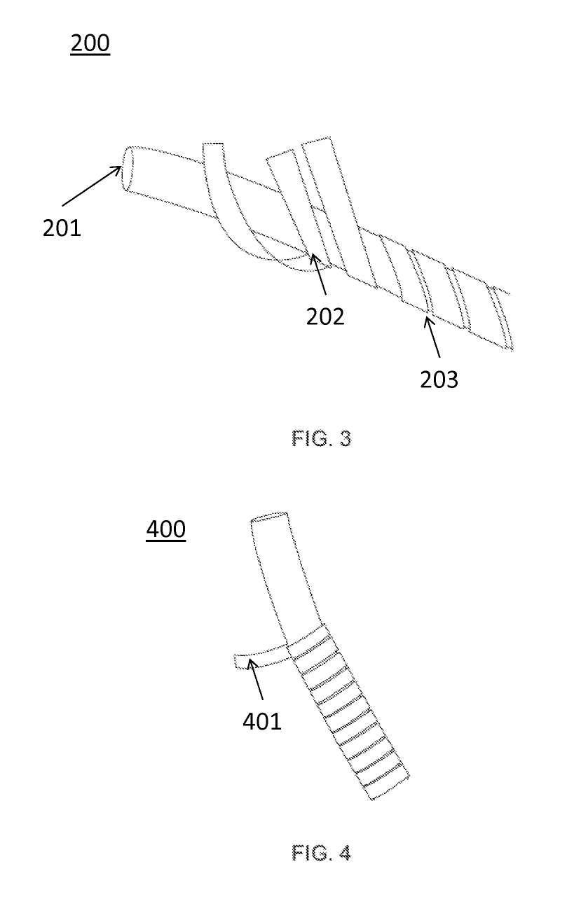

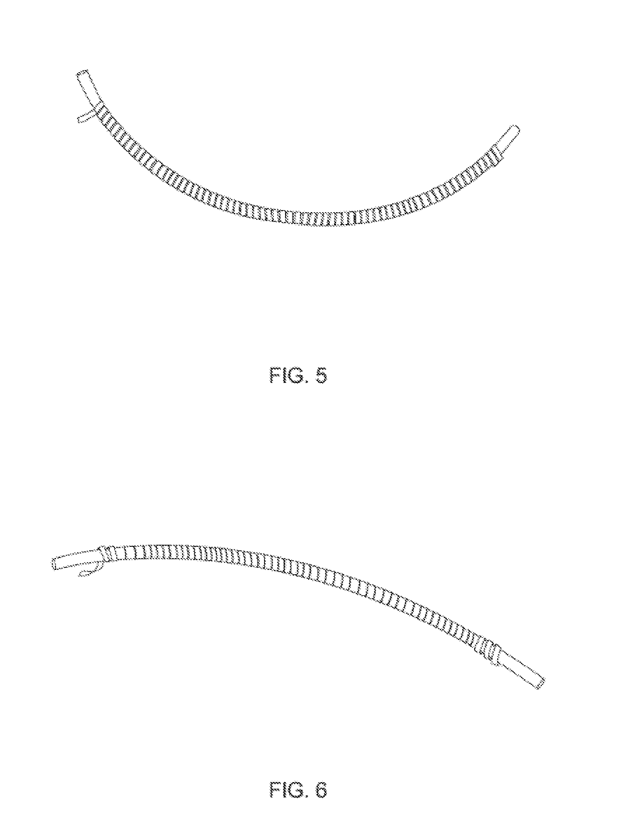

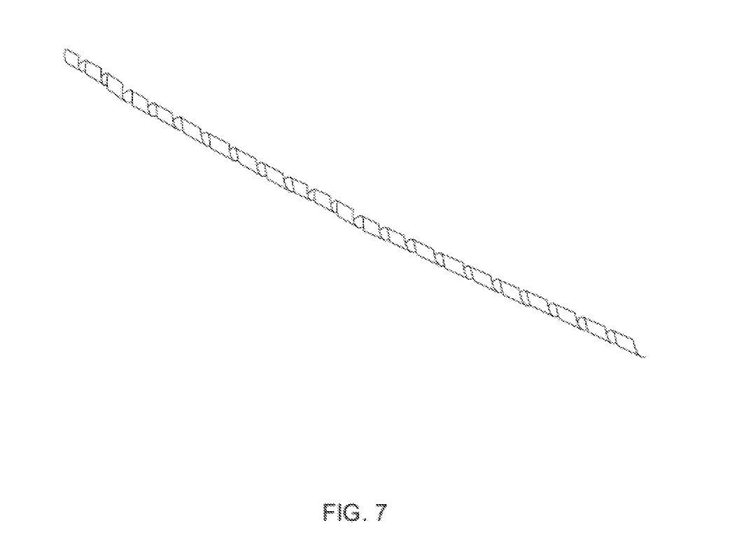

In another embodiment, as illustrated in FIGS. 2-3 a triple spiral wrapped tube 200 is illustrated. In this embodiment the single spiral wrap 102 is replaced by a triple spiral wrap 202 covering the flexible tubing 201. In yet another embodiment, the size of the spiral wrap 401 can be adjusted. FIGS. 4-5 illustrate a wide spiral wrapped tube 400, when compared to the single wrapped tube 100 of FIG. 1, where the size in width of the spiral wrap 401 is adjusted to change the flexibility characteristics of the final product.

As illustrated in the figures, the spiral wrap can be applied in several ways. The first criteria is the number of spirals being applied to a tube, in one embodiment, a single spiral 101 is shown, but it should be appreciated that multiple spirals, such as the triple spiral wrap 202, or any number of spirals can be used as desired.

Additionally, the width of the plurality of spirals can be adjusted as well. In general terms they are defined narrow or wide spirals, but any combination or comparison can be used during manufacturing.

After wrapping, the exterior can be coated or left un-coated depending of if additional animal resistance is necessary for the application or location in which the tubes will be deployed into the field.

Color can also be adjusted. Typically used colors are white, light green, or light blue but any color can be chosen and manufactured as required.

The spiral can also be made of many different materials, for example, steel, stainless steel, brass, copper, aluminum , and Kevlar.

The best mode of the present invention appears to be with aluminum as it offers the best combination of cost, workability, and corrosion resistance. Additionally, aluminum is readily recyclable and sourced from recycled materials making it a “green” product.

The spacing 203 between each spiral can also be increased or decreased in size, which effects weight, protection, and flexibility. Depending on the environment and other conditions, the wrapping can be adjusted to the specific environmental setting and threats.

Currently, experimental testing is underway to determine optimal spacing between the spirals to ensure they are still chew proof, while using the least amount of aluminum to reduce raw material consumption, cost, and weight.

The sole purpose of the reinforcement as applied to the tubing and taught by the present invention is to make the tubing resistant to animals chewing through and thus losing the vacuum in the system. The present invention is not concerned with increasing the pressure handling capacity or crush resistance properties of the tubing.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A chew proof tube comprising:
a flexible plastic tube; and
a single spiral wrap covering a flexible plastic tube in such a manner that the flexible tubing still maintains its flexibility for tight bends.

2. The tube of claim 1, wherein
the single spiral wrapped tube has a clear outer coating.

3. The tube of claim 1, wherein
the single spiral wrapped tube has a colored outer coating.

4. The tube of claim 3, wherein
the single spiral wrapped tube has a white outer coating.

5. The tube of claim 1, wherein
the single spiral wrap is bonded to the tube, eliminating the need for an outer coating on the tube.

6. The tube of claim 1, wherein
the single spiral wrap can be painted to the desired color for either ease of visibility or to camouflage the tubing into the setting as desired.

7. The tube of claim 1, wherein
a triple spiral wrapped tube is used.

8. The tube of claim 1, wherein
where the size in width of the spiral wrap is adjusted to change the flexibility characteristics of the final product.

9. The tube of claim 1, wherein
multiple spirals of any number can be used as desired.

10. The tube of claim 1, wherein
the width of the spirals can be adjusted as well.

11. The tube of claim 1, further comprising
a wrapping on the exterior of the spirals with an outer coating.

12. The tube of claim 11, wherein
the single spiral wrapped tube has a clear outer coating.

13. The tube of claim 12, wherein
the single spiral wrapped tube has a clear outer coating.

14. The tube of claim 1, wherein
the single spiral wrapped tube can be coated or left un-coated depending of if additional animal resistance is necessary for the application or location in which the tubes will be deployed into the field.

15. The tube of claim 11, wherein
colors are white, light green, or light blue.

16. The tube of claim 1, wherein
the spiral is made from one of the following materials: steel, stainless steel, brass, copper, aluminum, and Kevlar.

17. The tube of claim 1, wherein
the spacing between each spiral can also be increased or decreased in size, which effects weight, protection, and flexibility.
